(19) United States
(12) Patent Application Publication
(10) Pub. No.: US 2014/0375827 A1
(43) Pub. Date: Dec. 25, 2014

(54) Systems and Methods for Video System Management

(71) Applicant: Verint Systems, Inc., Herzilya Pituach (IL)

(72) Inventors: Oren Golan, Or-Yehuda (IL); Boaz Dudovich, Rehovot (IL); Shahar Daliyot, Rehovot (IL); Ron Schwartz, Tel-Aviv (IL)

(21) Appl. No.: 14/451,752

(22) Filed: Aug. 5, 2014

Related U.S. Application Data
(63) Continuation of application No. 13/014,077, filed on Jan. 26, 2011.
(60) Provisional application No. 61/298,430, filed on Jan. 26, 2010.

(51) Int. Cl. H04N 5/445; G11B 27/10; H04N 1/00

(52) U.S. Cl. CPC H04N 5/44543; H04N 1/00209; G11B 27/10; H04N 2101/00
USPC 348/207.1

(57) ABSTRACT

A video system comprises a video source and a video management system. The video management system is configured to receive video from the video source and process the video to generate a report containing information pertaining to activity within the video. The video management system displays the report and receives a selection of an element of the report. The video management system then displays a portion of the video associated with the selected element of the report in response to selection of the element.

### RELATED APPLICATIONS

This application is a continuation of U.S. patent application Ser. No. 13/014,077, filed on Jan. 26, 2011, which claims priority to U.S. Provisional Patent Application No. 61/298,430, entitled “Integration Between Analytics Tool and Video Data” filed on Jan. 26, 2010, all of which are hereby incorporated by reference in their entirety.

### TECHNICAL FIELD

Aspects of the invention are related, in general, to the field of video surveillance and monitoring.

### TECHNICAL BACKGROUND

Many common video systems include video cameras and video management systems. Video management systems receive and process streams of video or images which are captured by the video cameras. Many of these video systems process and store video in digital form. The video system may perform many different processes on the video including: storing, transferring, compressing, thinning, or various types of video analytics processes. The video system may also control the video cameras by sending pan, tilt, zoom, or other instructions to the video cameras.

Video systems are often used for surveillance, security, or other types of monitoring uses. In these applications, large amounts of video may be captured over extended periods of time. Extended segments of this captured video may contain little or no activity or may contain activity which is not initially of interest to the user of the system. The video management system is often capable of processing this large quantity of video to produce reports or statistics which summarize the activities contained in the video. These reports allow a user to gain an understanding of the activities or events in the video without necessarily having to watch extended segments of video.

### Overview

A video system comprises a video source and a video management system. The video management system is configured to receive video from the video source and process the video to generate a report containing information pertaining to activity within the video. The video management system displays the report and receives a selection of an element of the report. The video management system then displays a portion of the video associated with the selected element of the report in response to selection of the element.

### BRIEF DESCRIPTION OF THE DRAWINGS

FIG. 1 illustrates a video system.

FIG. 2 illustrates an operation of a video system.

FIG. 3 illustrates a video system in which a video management system application may be used to view reports and video.

FIG. 4 illustrates an example of a traffic report and associated video.

FIG. 5 illustrates an example of a path map and associated video.

FIG. 6 illustrates an example of a dwell map, an associated image, and associated video.

FIG. 7 illustrates a video management system.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

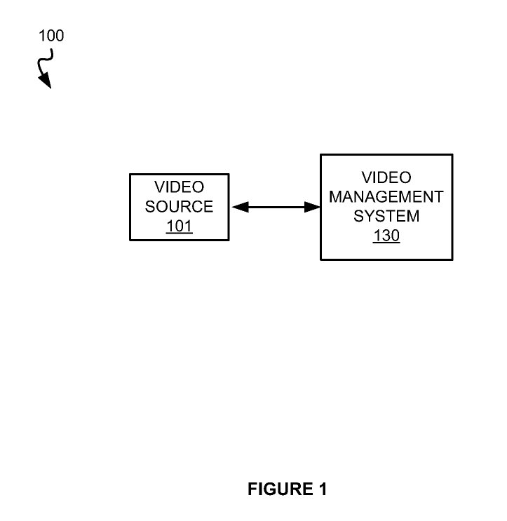

FIG. 1 illustrates video system 100. Video system 100 includes video source 101 and video management system (VMS) 130. VMS 130 receives video from video source 101 and performs processing on the video.

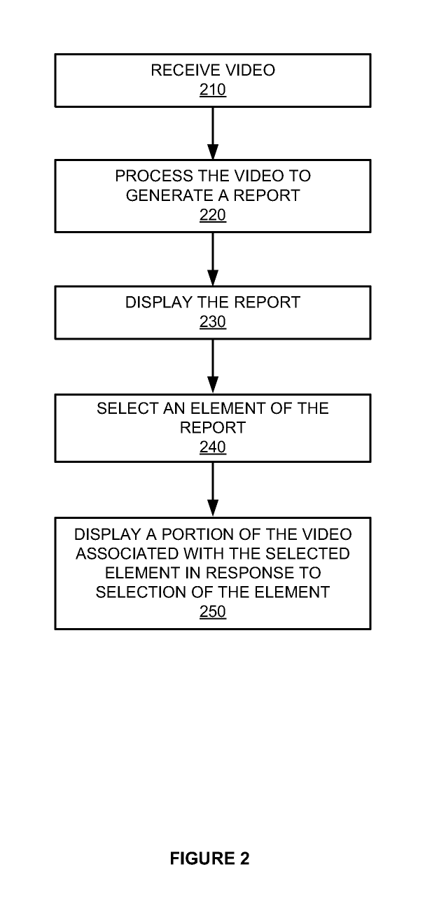

FIG. 2 illustrates an operation of video system 100. The steps of operation are indicated below parenthetically. VMS 130 receives video from video source 101 (210). VMS 130 process the received video to generate a report containing information pertaining to activity within the video (220). VMS 130 displays the report (230). When an element of the report is selected (240), VMS 130 displays a portion of the video which is associated with the selected element of the report in response to the selection of the element (250).

The operation of video system 100, as illustrated in FIG. 2, enables a user to view the report and discover important or interesting aspects of the video in an efficient manner without actually searching the video. By selecting an element of the report, the user can then view portions of the video which are related to the selected element of the report without having to view the entire video or without having to search through the video for those portions.

Referring back to FIG. 1, video source 101 may comprise any device having the capability to capture video or images. Video source 101 comprises circuitry and an interface for transmitting video or images. Video source 101 may be the device which performs the initial optical capture of the video or may be an intermediate transfer device. For example, video source 101 may be a video camera, a still camera, an internet protocol (IP) camera, a video switch, a video buffer, a video server, or other video transmission devices, including combinations thereof.

VMS 130 may comprise any device for receiving and processing video. VMS 130 may also be configured to display video. VMS 130 comprises processing circuitry and an interface for receiving video. VMS 130 may also comprise a display, an interface for sending information to be displayed on a separate device, or both. VMS 130 may also comprise memory, software, firmware, communication components, a power supply, structural support, or other components. VMS 130 may be a video processing system, personal computer, video analytics system, server, application specific circuitry, custom hardware, or some type of processing device, including combinations thereof.

VMS 130 is connected to video source 101 via one or more links which may use any of a variety of communication media, such as air, metal, optical fiber, or any other type of signal propagation path, including combinations thereof. The link may use any of a variety of communication protocols, such as internet, telephony, optical networking, wireless communication, wireless fidelity, or any other communication protocols and formats, including combinations thereof.

Although VMS 130 is illustrated as a single device, one skilled in the art will appreciate that the functions associated with VMS 130 may be spread across multiple devices, systems, or software applications in a variety of manners.

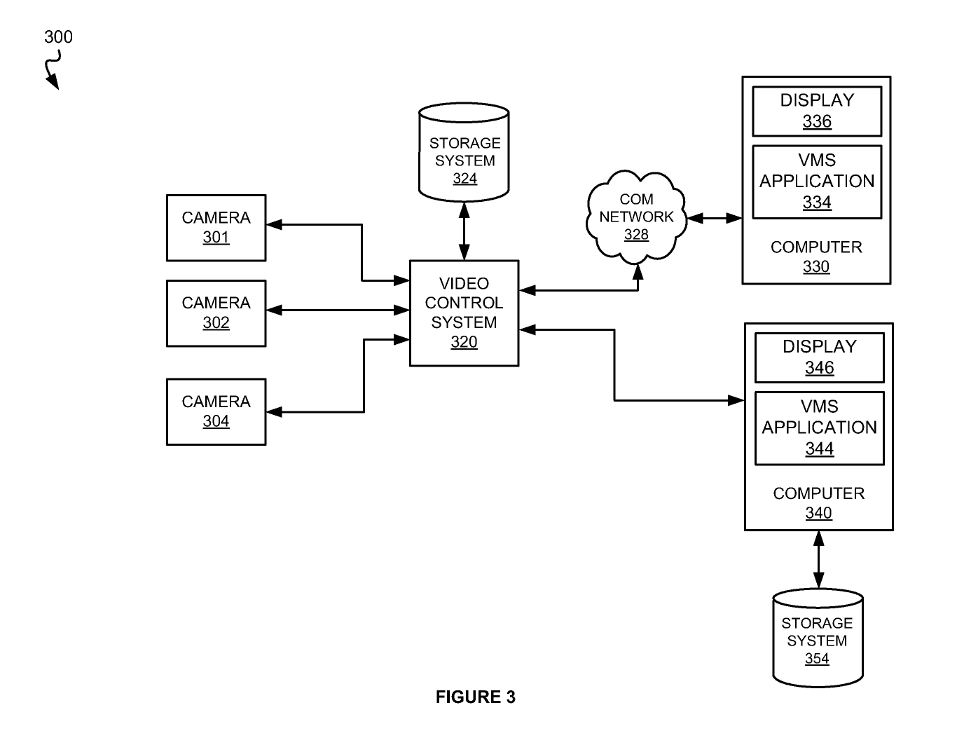

FIG. 3 illustrates video system 300 in which a VMS application running on a computer may be used to view reports and video from one or more video sources. Video system 300 is an example of video system 100 although video system 300 may have an alternate configuration or operate in an alternate manner. Video system 300 includes cameras 301-304. Video system 300 also includes video control system (VCS) 320, computer 330, computer 340, storage system 324, storage system 354, and communication network 328. Video system 300 enables a user of computer 330 or computer 340 to view reports which contain information gathered by processing video received from cameras 301-304. The user may select one or more elements of the report and view one or more segments of video associated with the selected elements of the report.

VCS 320 may comprise any device for processing or distributing video, video streams, or images. VCS 320 comprises processing circuitry and interfaces for receiving video. VCS 320 may perform various buffering, multiplexing, or distribution functions in order to make video from cameras 301-304 available to other devices, systems, or users. VCS 320 may also perform other control functions including instructing cameras 301-304 to pan, tilt, zoom, power cycle, perform diagnostics, or other instructions. VCS 320 may also control additional cameras or video sources which may be spread across multiple physical sites or locations.

VCS 320 may have a separate interface for transmitting video and other information or may do so through the same interface through which video and other information is received. VCS 320 may also comprise memory, software, firmware, communication components, a power supply, structural support, or other components. VCS 320 may be a video switching system, server, computing system, application specific circuitry, custom hardware, or some type of processing device, including combinations thereof.

Storage systems 324 and 354 are used for storage of video from the cameras as well as for storage of other information. Storage systems 324 and 354 comprise a communication interface and components for storing information or video. The storage components of storage systems 324 and 354 may comprise a disk drive, optical disk, flash memory, solid state memory, tape drive, or other device for storage of digital data, including combinations thereof. Storage systems 324 and 354 may also comprise additional interfaces for transmitting or receiving data, software, firmware, a power supply, structural support, or other components. Storage systems 324 and 354 may be servers, disk arrays, databases, or other devices which store digital data. When computer 330 requests video associated with a particular camera, VCS 320 may provide video or images retrieved from storage system 324 or may provide a live video stream from the camera.

Computer 330 and computer 340 are any of a variety of computers or processing systems which are capable of executing software applications. Computer 330 comprises display 336 and VMS application 334. Computer 340 comprises display 346 and VMS application 344. By executing the VMS applications, computers 330 and 340 process video and generate reports based on the processed video. The VMS applications also enable a user to select an element of a report and view video associated with the selected element. Computers 330 and 340 may also comprise memory, other software, firmware, communication components, a power supply, structural support, or other components. Computers 330 and 340 may be video processing systems, video analytics systems, personal computers, servers, programmable logic, custom hardware, or other types of processing devices, including combinations thereof.

As illustrated in FIG. 3, computer 340 communicates with VCS 320 over a direct link while computer 330 communicates with VCS 320 through communication network 328. The direct link may be comprised of one or more links which may use any of a variety of communication media, such as air, metal, optical fiber, or any other type of signal propagation path, including combinations thereof. Communication network 328 may be an Internet, intranet, dedicated network, wireless network, local area network, or other type of network, including combinations thereof.

In one example of operation of video system 300, cameras 301-304 are used to monitor shoppers in one or more retail stores. VMS application 344 is executed on computer 340 in order to allow the user to view and make use of video from cameras 301-304. Cameras 301-304 may be configured to monitor different stores, different departments of the same store, or may monitor the same department from different angles.

Using an interface on computer 340, VMS application 344 communicates with VCS 320. VMS application 344 requests and receives video captured by one or more of cameras 301-304. The video may be a live stream of video from one or more of cameras 301-304 or may be video which was previously acquired. In the latter case, VCS 320 may retrieve the previously acquired video from storage system 324. VMS application 344 may also receive other information relating to the configuration, identity, location, positioning, or status of one or more of cameras 301-304. VMS application 344 may also retrieve information or video from storage system 354.

VMS application 344 performs one or more of many possible image processing algorithms or processes on the received video. These processes may include image enhancement, cropping, thinning, compression, object identification, motion detection, or one or more of the many other video analytic processes which are known in the art. In video surveillance applications, much of the video may be of little interest because there is no activity or because the activity in those segments is not of interest to the user. For this reason, the user may not be interested in or may not have the time to view the video from beginning to end.

In addition, the user may be interested in using VMS application 344 to perform steps which summarize the information contain in the video into one or more reports. VMS application 344 may display a report on display 346 or may transmit it to another device for viewing. This process allows the user to view charts, statistics, or other consolidated information which summarizes one or more aspects of the information contained in the video without necessarily viewing the video. Many types of metrics or statistics may be used in the report to outline information contained in the video.

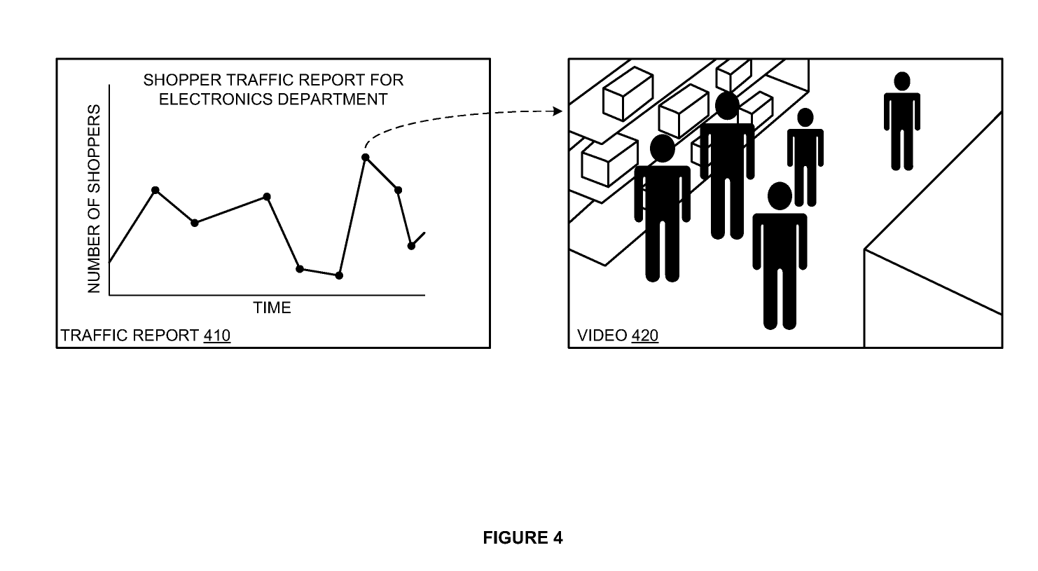

FIG. 4 illustrates one example of a report which may be generated by VMS application 344. In this example, VMS application 344 processes video of an electronics department in a retail store received from camera 302 through VCS 320. VMS application 344 processes the video and determines the number of people in the department, or in the range of camera 302, at various points in time. VMS application 344 then generates and displays traffic report 410. Traffic report 410 is a shopper traffic report which is a graphical chart illustrating the number of shoppers in the electronics department versus time. Many other types of charts, reports, or summaries are possible.

When viewing traffic report 410, particular areas of the chart or data points on the chart may be of more interest to the user than others. For example, periods of time when there are many shoppers in the department may be of most interest because there is an abundance of consumer behavior information to be observed or because the presence of a large number of people may indicate an unexpected event or activity. Many other reasons or motivations for selecting an area or data point of the chart exist.

In this example, the user selects the data point on traffic report 410 associated with the largest number of people being in the electronics department. The selection may be made through use of a keyboard, mouse, touchscreen, or other input device which is associated with computer 340. The selection may be made by placing a cursor over the data point, clicking on the data point, or otherwise selecting it. The connectivity between VMS application 344 and a VMS system which allows the selection to be recognized and acted upon may be accomplished through use an application program interface (API).

In response to the selection of the data point, VMS application 344 retrieves video associated with the data point and displays it on display 346. In other words, VMS application 344 displays video 420 which is a segment of the video from camera 302 which shows the large number of people in the department. In this way, the user can select data points and quickly view video associated with those data points without having to parse through long periods of video which are not of interest or not of interest at the time. Video 420 may be retrieved from storage system 324 through VCS 320, from storage system 354, or from some other location. When VMS application 344 processes the video to generate traffic report 410, meta data may be generated which links the data points on traffic report 410 to indexed segments of the video. This allows the video segments to be identified and retrieved quickly and with minimal further processing when a data point is selected.

In a variation of the example above, VMS application 344 may retrieve and display multiple video segments associated with the selected data point. Multiple video segments may be associated with the same data point because there were multiple camera views of the same area, because the data point represents more than one occurrence of the circumstances represented by the data point, or for other reasons. In this case, VMS application 344 may display the multiple video segments on display 346 simultaneously or may display them sequentially.

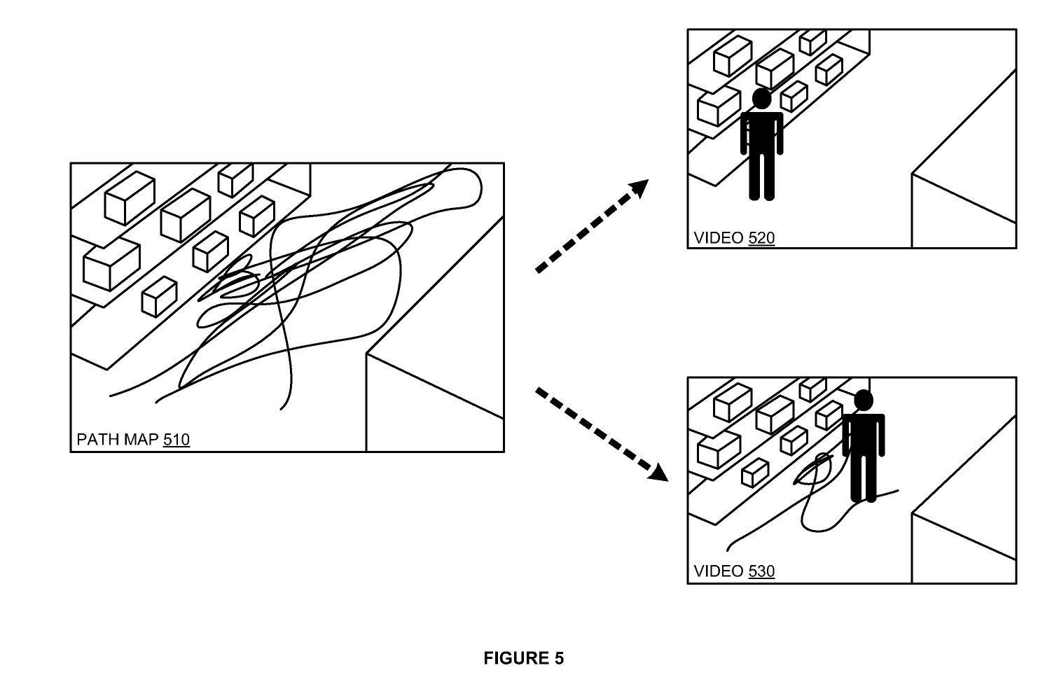

FIG. 5 illustrates another example of a report which may be generated by VMS application 344. In this example, VMS application 344 processes video from one of the cameras and documents the path taken by each shopper as he or she walks through the store. VMS application 344 performs this process for multiple shoppers and overlays the path information on an image of the department or a single from of the video from the department. The result is path map 510 which cumulatively shows the paths taken by multiple shoppers without showing the shoppers themselves. This may be useful in order to analyze customer behavior, understand relationships between products, make product shelf placement decisions, or for other reasons.

When viewing path map 510, the user of VMS application 344 may be interested in viewing the actual video of the customer moving through the area along one of the paths illustrated in path map 510. For example, the user may see one path in which a customer appears to go back and forth between two different products repeatedly. In this case, the user may be interested in seeing more details about exactly what the customer is looking at or what the customer is doing while this takes place. The selection may be made through use of a keyboard, mouse, touchscreen, or other input device which is associated with computer 340. The selection may be made by placing a cursor over the path, clicking on the path, or otherwise selecting it. Many other reasons or motivations for selecting a particular path from path map 510 may exist.

In response to the selection of the path, VMS application 344 retrieves and displays video associated with the selected path. In other words, VMS application 344 displays video 520 which is the segment of video which shows the customer walking to the spots which generated the selected path. In this way, a user can view path information for many customers in a single view, select one or more paths of interest, and view a video segment of the customer traversing that path without having to manually search the video for that segment or view other segments of video which are not of interest.

When VMS application 344 processes the video to generate path map 510, meta data may also be generated which links the paths on path map 510 to indexed segments of the video. In this way, video associated with a path can be quickly retrieved by VMS application 344 without further processing or searching when that path is selected. Video 520 may be retrieved from storage system 324 through VCS 320, from storage system 354, or from some other location.

In a variation of the example above, VMS application 344 may display information from path map 510 in combination with video associated with the selected path. For example, when the user selects a path from path map 510, VMS application 344 retrieves and displays video 530 which is associated with that path, as in the previous example. However, in this case, VMS application 344 also overlays a graphical representation of the selected path on the display of the video in order to allow the user to better see where the customer has been and where the customer is going in the video segment. In other words, given a selection of the same path from path map 510, the only difference between video 520 and video 530 is that a trace of the path is visually or graphically overlaid on the latter.

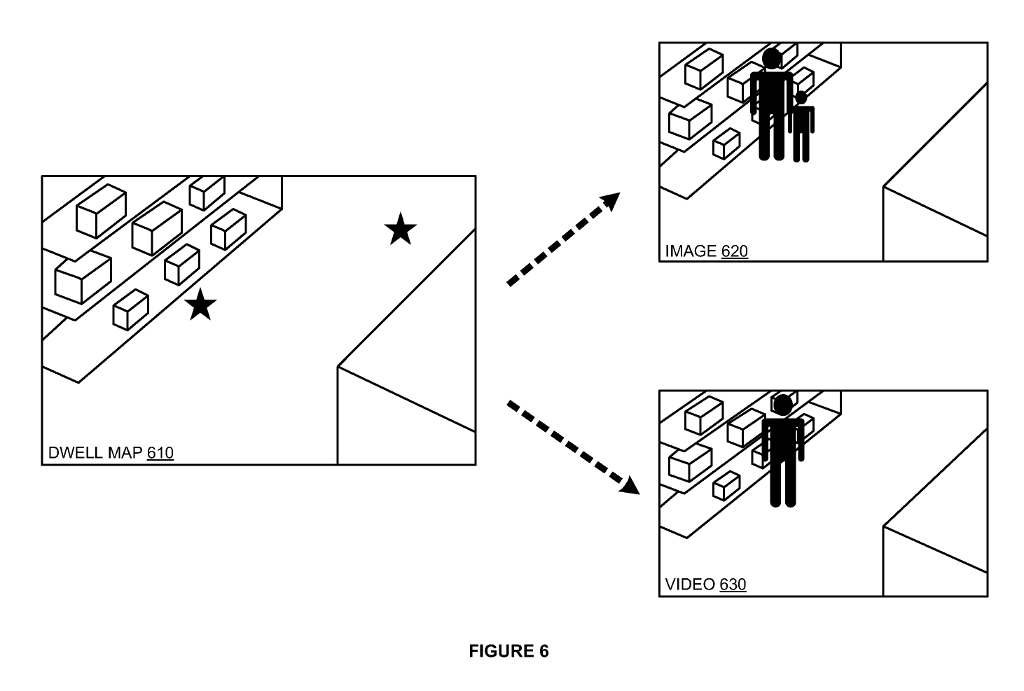

FIG. 6 illustrates another example of a report which may be generated by a VMS or VMS application. In this example, VMS application 334 processes video received from camera 304 through communication network 328. The processing identifies and documents locations where customers stayed, or dwelled, for extended periods of time. The period of time a customer must spend in a single location necessary to result in a dwell location could be set to any value by a user. It may be as short as several seconds or may be measured in minutes. In addition, the system may also be configured to treat minor movements as not being movements with respect to the determination of whether the customer has remained in the same location.

VMS application 334 performs this process for multiple shoppers and overlays the dwell locations on an image of the store department or a single frame of the video which shows the department. The result is dwell map 610 which shows one or more dwell locations, represented by stars in this example. Each dwell location may be associated with one or more people. Dwell locations may be useful in order to analyze customer buying habits, determine if store associates are providing proper assistance, assess customer confusion, determine if employees are idle, or for other reasons. In addition, store security may wish to designate viewing of video of customers who dwell highest priority because these may be the most likely scenarios in which thefts occur.

When viewing dwell map 610, the user of VMS application 334 may be interested in viewing an image or video of a person who dwelled at a location indicated in dwell map 610. The user may be interested in seeing more details about exactly what the person was looking at or what the person was doing while he dwelled. The selection may be made through use of a keyboard, mouse, touchscreen, or other input device which is associated with computer 330. The selection may be made by placing a cursor over the dwell point, clicking on the dwell point, or otherwise selecting it. Many other reasons or motivations for selecting a particular dwell point from dwell map 610 may exist.

In response to the selection of the dwell point, VMS application 334 retrieves and displays an image associated with selected dwell path, a video segment, or both. Image 620 is an example of an image or single frame of video which is displayed on display 336 in response to the selection. In some cases, the user may only need to identify the person so an image or single frame of video may be sufficient.

Video 630 is an example of a video segment which may be displayed in response to the selection of a dwell point on dwell map 610. Video 630 is the segment of video which shows what the person was doing while he remained in the dwell location. In this way, a user can view video segments of people who dwell without having to manually search the video for those segments or view other segments of video which are not of interest.

When VMS application 334 processes video to generate dwell map 610, meta data may also be generated which links the dwell locations on dwell map 610 to indexed segments of the video. In this way, video associated with a dwell location can be quickly retrieved by VMS application 334 without further processing or searching when that dwell location is selected.

In a variation of this example, multiple people may have dwelled in the same location indicated on dwell map 610. When the user of VMS application 334 selects this dwell location, multiple responses are possible. First, VMS application 334 could display video segments of each person who dwelled there simultaneously. Second, VMS application 334 could display video segments of each person who dwelled there sequentially. Third, VMS application 334 could display an image, like image 620, of each person who dwelled at that location and allow the user to select from those images in order to determine which video is displayed.

Several examples of possible reports are discussed above and many other types of reports are possible. In addition to different types of reports, a user may achieve different results by generating a report for video spanning different time periods. For instance, a store may be closed from 9 PM until 8 AM. A report may be generated specifically for video covering that time period. The report may list times at which any activity or movement was detected in the store since little or no activity was expected during the closed hours. The user may simply be able to click on the listed times in order to view a few seconds or minutes of video associated with each of those events rather than watching or scanning the 11 hours of video to view the events. In this way, the user can quickly access and view each event to determine if further investigation is necessary.

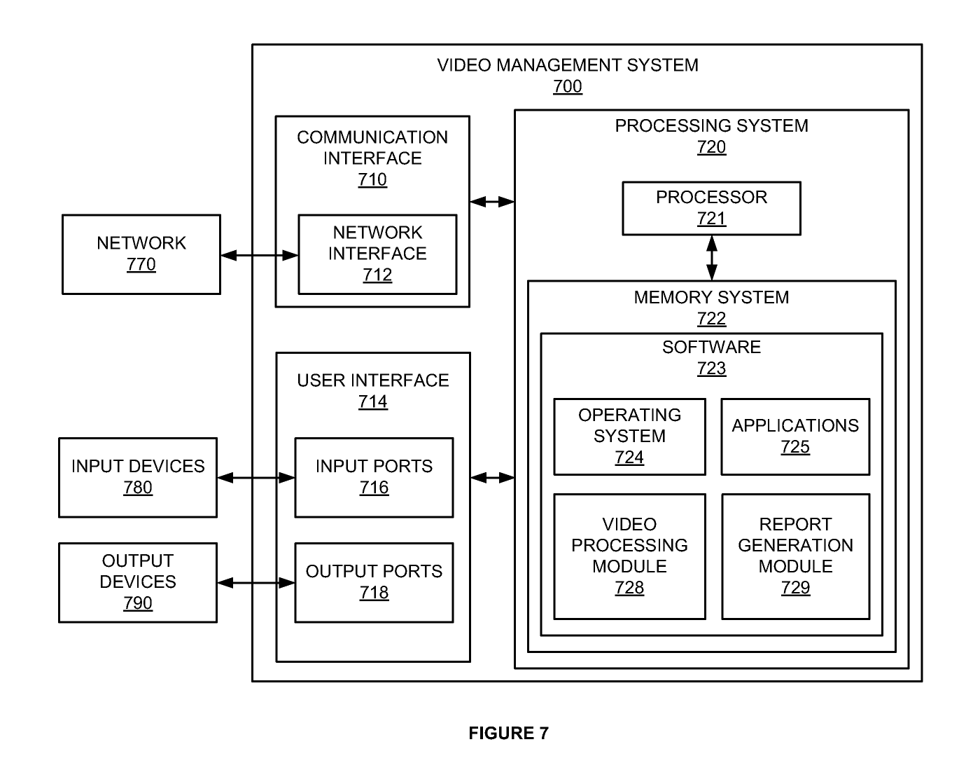

FIG. 7 illustrates VMS 700. VMS 700 includes communication interface 710, user interface 714, and processing system 720. Processing system 720 is linked to communication interface 710 and user interface 714 through communication links.

Communication interface 710 includes network interface 712. Communication interface 710 includes components that communicate over communication links, such as network cards, ports, RF transceivers, processing circuitry and software, or some other communication device. Communication interface 710 may be configured to communicate over metallic, wireless, or optical links. Communication interface 710 may be configured to use TDM, IP, Ethernet, optical networking, wireless protocols, communication signaling, or some other communication format, including combinations thereof. Network interface 712 is configured to connect to external devices over network 770. Network 770 is an example of communication network 328 although network 770 may have an alternate configuration or operate in an alternate manner.

User interface 714 includes input ports 716 and output ports 718. Input ports 716 are configured to connect to input devices 780 such as a keyboard, a mouse, a touchscreen, a storage system, or other input devices. Output ports 718 are configured to connect to output devices 790 such as a display, a storage system, a printer, or other output devices.

Processing system 720 includes processor 721 and memory system 722. Processor 721 includes microprocessor and other circuitry that retrieves and executes operating software from memory system 722. Memory system 722 comprises software 723. Memory system 722 may be implemented using random access memory, read-only memory, a hard drive, a tape drive, flash memory, optical storage, or other memory apparatus.

Software 723 comprises operating system 724, applications 725, video processing module 728, and report generation module 729. Software 723 may also comprise additional computer programs, firmware, or some other form of non-transitory, machine-readable processing instructions. When executed by processor 721, operating system 724 directs processing system 720 to operate VMS 700 as described herein using applications 725, video processing module 728, and report generation module 729. Video processing module 728 directs processing system 720 to process video received from video sources to identify people, determine paths, or identify dwell locations. Report generation module 729 directs processing system 720 to generate and display reports containing consolidated information about the content of the processed video.

It should be understood that the functions and features of VMS 700 illustrated in FIG. 7 may be implemented in or performed by other devices, including other devices within video system 300.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a video management system, the method comprising:
receiving video captured by a camera, wherein the video is received by a video management system executing on a computer;
processing the video by the video management system using an image processing algorithm to generate a report containing information pertaining to activities viewable within the video;
displaying the report using a graphical user interface;
receiving a selection of an element displayed in the report, wherein the element is selected by interacting with the graphical user interface;
generating metadata by the video management system that links the selected element to indexed segments of the video; and
in response to receiving the selection of an element of the report, displaying at least one of the segments of the video associated with the selected element using the metadata.

2. The method of claim 1, wherein the report comprises foot traffic report indicating a quantity of people appearing in an area of a scene during a specified time period in the captured video.

3. The method of claim 2, wherein selecting an element of the report comprises placing a cursor over a data value on the traffic report.

4. The method of claim 1, wherein the report comprises a path map illustrating a path taken by a person moving through an area of a scene in the captured video.

5. The method of claim 4, wherein selecting an element of the report comprises placing a cursor over the path on the path map.

6. The method of claim 1, wherein the report comprises a dwell map illustrating a dwell location as indicated by a person remained for at least a specified period of time in a scene in the captured video.

7. The method of claim 6, wherein selecting an element of the report comprises placing a cursor over the dwell location.

8. The method of claim 1, wherein the segment of the captured video comprises a single frame of the video.

9. The method of claim 1, wherein receiving video comprises receiving video from a plurality of video cameras.

10. The method of claim 1, further comprising displaying at least another one of the segments of the video associated with the selected element using the metadata.

11. A video system comprising:
a video source; and
a video management system configured to:
receive video captured by a camera, wherein the video is received by a video management system executing on a computer;
process the video by the video management system using an image processing algorithm to generate a report containing information pertaining to activities viewable within the video;
display the report using a graphical user interface;
receive a selection of an element displayed in the report, wherein the element is selected by interacting with the graphical user interface;
generate metadata by the video management system that links the selected element to indexed segments of the video; and
in response receiving the selection of an element of the report, display at least one of the segments of the video associated with the selected element using the metadata.

12. The video system of claim 11, wherein the report comprises foot traffic report that indicates a quantity of people appearing in an area of a scene during a specified time period in the captured video.

13. The video system of claim 11, wherein the report comprises a path map that illustrated a path taken by a person moving through an area of a scene in the captured video.

14. The video system of claim 11, wherein the report comprises a dwell map that illustrates a dwell location as indicated by a person remained for at least a specified period of time in a scene in the captured video.

15. The video system of claim 11, wherein the video is received from a plurality of video cameras.

16. The video system of claim 11, wherein the video management system is further configured to display at least another one of the segments of the video associated with the selected element using the metadata.

17. A non-transitory computer readable medium having program instructions stored thereon that, when executed by a video management system, direct the video management system to:
receive video captured by a camera, wherein the video is received by a video management system executing on a computer;
process the video by the video management system using an image processing algorithm to generate a report containing information pertaining to activities viewable within the video;
display the report using a graphical user interface;
receive a selection of an element displayed in the report, wherein the element is selected by interacting with the graphical user interface;
generate metadata by the video management system that links the selected element to indexed segments of the video; and
in response receiving the selection of an element of the report, display at least one of the segments of the video associated with the selected element using the metadata.

18. The non-transitory computer readable medium of claim 17, wherein the report comprises foot traffic report that indicates a quantity of people appearing in an area of a scene during a specified time period in the captured video.

19. The non-transitory computer readable medium of claim 17, wherein the report comprises a path map that illustrates a path taken by a person moving through an area of a scene in the captured video.

20. The non-transitory computer readable medium of claim 17, wherein the report comprises a dwell map that illustrates a dwell location as indicated by a person remained for at least a specified period of time in a scene in the captured video.
